(19) United States
(12) Patent Application Publication
(10) Pub. No.: US 2025/0339774 A1
(43) Pub. Date: Nov. 6, 2025

(54) RETRAINING PLAYERS TO RESUME GAMEPLAY USING KEY EVENT REPLAY MODE

(71) Applicant: Sony Interactive Entertainment Inc., Tokyo (JP)

(72) Inventors: Joohyun Bae, San Mateo, CA (US); Travis Baurmann, San Mateo, CA (US); Derek Parker, San Mateo, CA (US)

(21) Appl. No.: 18/654,849

(22) Filed: May 3, 2024

(51) Int. Cl. A63F 13/533; A63F 13/537; A63F 13/79

(52) U.S. Cl. CPC A63F 13/533; A63F 13/537; A63F 13/79

(57) ABSTRACT

Methods and systems for providing a training option to improve input skills of the user include detecting selection of the training option for a video game. Responsive to the training option selection, a plurality of minigames are presented at a user interface for user selection. Each minigame is selected to include a portion of the video game that requires distinct set of input skills to progress in the video game. User selection of a minigame is detected and an executable code for the portion of the video game is instantiated for user practice of the distinct set of input skills. The input skills exhibited by the user during gameplay of the minigame is monitored to identify an amount of progress made in the portion of the video game. Updates are provided at the user interface for user interaction, based on the input skills exhibited by the user.

### BACKGROUND OF THE INVENTION

### 1. Field of the Invention

The present disclosure relates to assisting a user in playing a video game, and more specifically providing a training option to the user to refresh and/or train their the input skills for the video game prior to attempting gameplay of the video game.

### 2. Description of the Related Art

Video gaming industry has grown in popularity and represents a large percentage of the entertainment market and interactive content generated worldwide. Various types of video games are available for playing. There are single-player video games and multi-player video games. In the case of multi-player video games, the users can play individually against one another or can be part of a team of users playing against at least one other second team. The users of the multi-player video games can be co-located or remotely located from one another. The player(s) select a video game for game play and provide game inputs. The game inputs are used to affect a game state of the video game and to update game data. The updated game data is used to generate game scenes that are returned to client device(s) of the player(s) for rendering. In the case of the multi-player video game, the game inputs of the different players are used to affect the game state and to synchronize the game data returned to the client devices associated with the different players.

Oftentimes, a user may step away from playing the video game either due to game fatigue or due to other commitments. Game fatigue, for example, may be due to lack of progress made by the user in the video game leading to frustration and lack of interest in the video game. Frustration and lack of interest can lead to loss of users for the video game. In order to realize return on investment, the game developer, game sponsor, game content distributor may have to find ways to lure the user back. One way of luring the users back to playing the video game is by providing incentives to the users. The incentives may be in the form of monetary incentives or game-related incentives. Game-related incentives may include providing access to additional video games, providing additional chances, access to additional portions of video game, additional game tools or game winnings/bonus points/currencies, etc. Alternately, the game-related incentives can include adjusting attributes of the video game, such as reducing speed of the video game to a level the user is comfortable with, adjusting complexity (e.g., easy vs. medium vs. hard level), providing additional opportunities or chances for the user to complete. These incentives, although trying to help the user, may make the user feel that they got a less than a full version of the game, leading to further user frustration. Although the incentives are supposed to assist and motivate the user to select the video game for gameplay, these incentives may actually turn the user away.

In some other cases, the user may have forgotten the inputs or the sequence of inputs or platform-specific inputs needed for the video game. This can be due to the amount of time that has elapsed since the user last played the game or it could be due to the hardware platform where the video game is executing, or the input device used to provide the inputs for the video game. Game inputs can vary from one platform to another and from one input device to another and the user may need to refresh on the platform-specific or input device-specific inputs. Traditional ways of teaching the user are to provide brief write-ups of what the video game is about and a brief tutorial of the different controls used to provide the input during initial setup. However, such brief write-ups or tutorials may not be sufficient to entice the user, especially if the inputs have to be provided in certain ways.

It is in this context that embodiments of the invention arise.

### SUMMARY OF THE INVENTION

Implementations of the present disclosure relate to systems and methods for

providing assistance to a user to refresh their memory of the input skills needed to progress in a video game. The input skills needed to progress in the video game can, for example, include a type, a sequence, a speed, a vector attribute, a scalar attribute, etc., of inputs. These input skills can be specific for the video game or specific to a hardware platform on which the video game is executing and/or from where the user is accessing the video game or specific to an input device used for providing the inputs during interaction with the video game. As each hardware platform may allow specific type of inputs, each input device may be configured to provide specific type of inputs, the user will need to refresh on the platform-specific or input device-specific inputs needed so that the user will be able to provide the appropriate inputs during gameplay to progress in the video game. Alternately, the user may be accessing the video game for gameplay after a long period of time (e.g., 1, 2 or 3 months or a year). In this case, the user may have walked away from the video game due to game fatigue or due to other commitments. The game fatigue may be a result of lack of progress by the user due to the user not having the necessary input skills to overcome challenges in specific portions of the video game. Conventionally, the user gains the necessary input skills by playing the video game repeatedly and slowly gaining the skills required for playing the video game. However, these incremental improvement in the input skills can be slow and time consuming leading to further frustration and, in some cases, potentially cause the user to loose interest in the video game.

To avoid such frustration and to keep the user's interest in the video game, systems and methods are provided to assist the user in refreshing or improving the input skills needed to play different portions of the video game. The system and methods are used to analyze user inputs provided by the user during prior gameplay sessions to identify the input skills possessed by the user and the input skills required to progress in different portions of the video game attempted by the user. Based on the analysis, the system identifies portions of the video game that the user can benefit from practicing to gain the needed input skills, generate minigames for the identified portions of the video game and present the generated minigames on a user interface for the user to select and practice. The portions of the video game used to generate the minigames are portions that the user may have already attempted during prior gameplay sessions and not been successful or had difficulty in completing. The identified portions are selected to preserve a semblance of the storyline that the user is already exposed to, so as to avoid spoiler alerts.

A game skill training module executing on a server of a computing system (e.g., cloud system, game console system, etc.) analyzes the inputs provided by the user during prior gameplay session(s) of the video game, identifies portions of the video game the user has previously attempted, and generates minigames for one or more portions of the video game that the user previously attempted and for which the system determines the user may require additional practice to master the necessary input skills required for playing the corresponding portions of the video game. The portion of the video game used to generate each minigame can include at least one key event. The analysis is performed by extracting the various features of the inputs provided by the user and the expected inputs provided by the game developer to generate and train an artificial intelligence (AI) model. The AI model is then used to understand the input skills possessed by the user, the input skills required for progressing in the different portions of the video game that the user previously attempted, the level of difficulty experienced by the user when attempting the different portions of the video game, the type of character used to represent the user in the video game, the type of inputs provided by the character representing the user, etc. The generated AI model is refined using subsequent inputs from the user. In addition to considering the inputs from the user, the generated AI model can also be refined using inputs of other users who have attempted the different portions of the video game, wherein the inputs of the other users can include the type of inputs provided by other characters with characteristics that are similar to the character of the user. As more and more input data becomes available (based on subsequent game inputs from the user and/or other users), the AI model is generatively refined.

Outputs from the AI model are used to identify the portions of gameplay of the video game where the user can benefit from further training and specific other portions of the video game that were already attempted by the user and included the needed inputs for training the user. The game skill training module uses the portions of the video game identified from the outputs of the AI model to generate the minigames and forward the minigames to the user for practicing. The user can select any one or more of the minigames and practice their inputs to improve their input skills before attempting gameplay of the video game.

In one implementation, a method to provide training to a user for playing a video game, is provided. The method includes detecting selection of a training option available for a video game selected by the user for gameplay. The training option is selected from a user interface rendered on a client device and used to allow the user to improve on input skills for use during the gameplay of the video game. In response to the user selection of the training option, a plurality of minigames is identified and forwarded to the client device for rendering on the user interface. The plurality of minigames is identified based on analysis of game inputs collected from prior gameplay session(s) of the user. Each minigame includes a portion of the video game that requires a distinct set of input skills to progress in the portion of the video game. Selection of a minigame from the plurality of minigames is detected and, in response, executable code of the portion of the video game included in the minigame is instantiated to allow the user to practice the distinct set of input skills. The input skills exhibited by the user are monitored during gameplay of the minigame to identify an amount of progress made by the user in said portion of the video game. Updates are provided for rendering at the user interface, based on the input skills exhibited by the user. The updates allow the user to improve their input skills and use the improved input skills to progress in the video game. The method operations are performed by a game skill training module executing on a server computing device that is communicatively coupled to the client device.

In another implementation, a method for providing training to a user for playing a video game, is provided. The method includes detecting selection of a video game for gameplay by a user. The method also includes determining an amount of time that has elapsed since the user previously selected the video game for gameplay. When the amount of time elapsed exceeds a predefined period of time, a training option is presented on a user interface to enable the user to refresh their input skills for use in the gameplay of the video game. When the user selects the training option, a plurality of minigames is presented on the user interface for user selection. Each minigame is identified to include a portion of the video game that requires distinct set of input skills to enable the user to improve their input skills for progressing in the video game. Selection of a minigame by the user is detected and, in response, executable code of the portion of the video game included in the selected minigame is instantiated allowing the user to practice the distinct set of input skills. The input skills exhibited by the user are monitored during gameplay of the minigame to identify an amount of progress made by the user in the portion of the video game, and the user interface is updated, based on the input skills exhibited by the user. The updates allow the user to improve their input skills and use the improved input skills to progress in the video game. The method operations are performed by a game skill training module executing on a server computing device that is communicatively coupled to the client device.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a system that is used to provide training assistance to a user to improve input skills for use during gameplay of a video game, in accordance with one implementation.

FIG. 2 identifies sub-modules of a game skill training module executing on a server of a computing system and used for training a user to improve their input skills for use in gameplay of a video game, in accordance with one implementation.

FIG. 3 illustrates flow of data used for training a user to improve their input skills for use during gameplay of a video game, in accordance with one implementation.

FIG. 4 illustrates an example user interface used for providing different options for training a user to improve their input skills for use during gameplay of the video game, in accordance with one implementation.

FIG. 5 illustrates components of an example system that can be used to process requests from a user, provide content and assistance to the user to perform aspects of the various implementations of the present disclosure.

### DETAILED DESCRIPTION

Broadly speaking, implementations of the present disclosure include systems and methods for providing a training option to allow a user to refresh their input skills so they can progress in a video game and have satisfactory gameplay experience. A game skill training module executing on a server computing device is used to evaluate the inputs provided by the user during one or more prior gameplay session(s) of the video game to understand the input skills acquired by the user during prior gameplay session(s) of the video game, and the input skills required to complete the different portions of the video game in order to progress in the video game. In some cases, the user may have not played the video game for an extended period of time. Depending on the amount of time that has elapsed between the prior and current gameplay sessions, the user may need to train in order to refresh their input skills so that they can have a satisfactory gameplay experience for the video game. In other cases, the user may have faced difficulty in achieving certain levels or portions of the game and may have left the video game out of frustration. In order to entice the users back to playing the video game, a game skill training module is used to evaluate the amount of time elapsed between the prior and current gameplay sessions of the user for the video game, the level of progress made by the user during the prior gameplay session(s), the input skills exhibited by the user during prior gameplay sessions, the input skills required for progressing in the video game, etc. Based on the evaluation, the game skill training module can identify certain portions of the video game that can be used to refresh the user's memory and/or to train the user in obtaining the needed input skills to progress in the video game.

For instance, the game skill training module may be used to analyze the inputs provided during a prior gameplay session of the user for the video game to identify specific key events that the user attempted, analyze the actions provided by the user and the game inputs defined by the game developer for achieving the identified key events to determine if the user struggled with and/or could benefit from revisiting (i.e., refreshing or training) the input skills required for successfully completing the challenges identified in the key events. A gameplay recording generated or gameplay data collected during the prior gameplay session of the user can be used in the analysis by the game skill training module to monitor the various key events attempted by the user, specific ones of the key events the user successfully completed, certain ones of the key events that the user attempted but was unsuccessful in completing and details of such unsuccessful attempts (e.g., number of unsuccessful attempts, level of progress made within the unsuccessful attempts, the inputs provided by the user during such unsuccessful attempts, etc.). The game skill training module can query the game logic of the video game to determine the inputs expected for successfully completing such key events. The knowledge obtained from the game logic is used in the analysis of the prior gameplay inputs provided by the user to identify portions of the video game that the user can benefit by revisiting. The identified portions are then used to generate a series of minigames for the user. Each minigame generated from the analysis includes a portion of the video game with one or more of the key events that require a distinct set of input skills focusing on a particular aspect of gameplay of the video game. The distinct set of inputs skills, in some implementations, are tailored for a type of character representing the user in the video game and are, therefore, tailored for the specific needs of the user. The user can select the minigame to practice and refine their input skills related to specific challenges that they faced for certain key events during one or more prior gameplay sessions.

The series of minigames may be provided in a sandbox format/environment allowing the user to select the minigames in any order (i.e., non-linear manner) to practice and improve their inputs skills. The user's selection of a minigame is detected, execution code of the selected minigame is instantiated, and the gameplay of the portion of the video game included in the selected minigame is monitored by the game skill training module. Based on the monitoring, the game skill training module can generate additional minigames to allow the user to further improve their input skills. The additional minigames may be generated to vary in complexity (i.e., adapt to the difficulty), based on how well the user has mastered the required input skills by practicing gameplay of the selected minigame. The monitoring game inputs and generating the minigames with varying complexity is to ensure that the practice sessions are challenging and beneficial to the user.

Monitoring the gameplay of the minigame includes providing real-time feedback to the user. The real-time feedback, based on user's performance in the attempted minigame, can provide constructive suggestions and tips to ensure that the user not only practices but also understands the nuances of the gameplay mechanics. Once the game skill training module determines that the user has acquired the necessary skill set for attempting the video game, the user can be seamlessly transitioned back to the video game to allow the user to attempt the gameplay of the video game. The transitioning can be from a resumption point, wherein the resumption point can be a point in the video game where the user paused or stopped during prior gameplay session of the video game and the user can use the acquired input skills from the guided practice to successfully attempt the challenges of the video game with confidence. The minigames generated based on the user's input needs provide valuable tutorial for the user to encourage the user to return to the video game and also contributes to a more personalized and enjoyable gaming experience.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

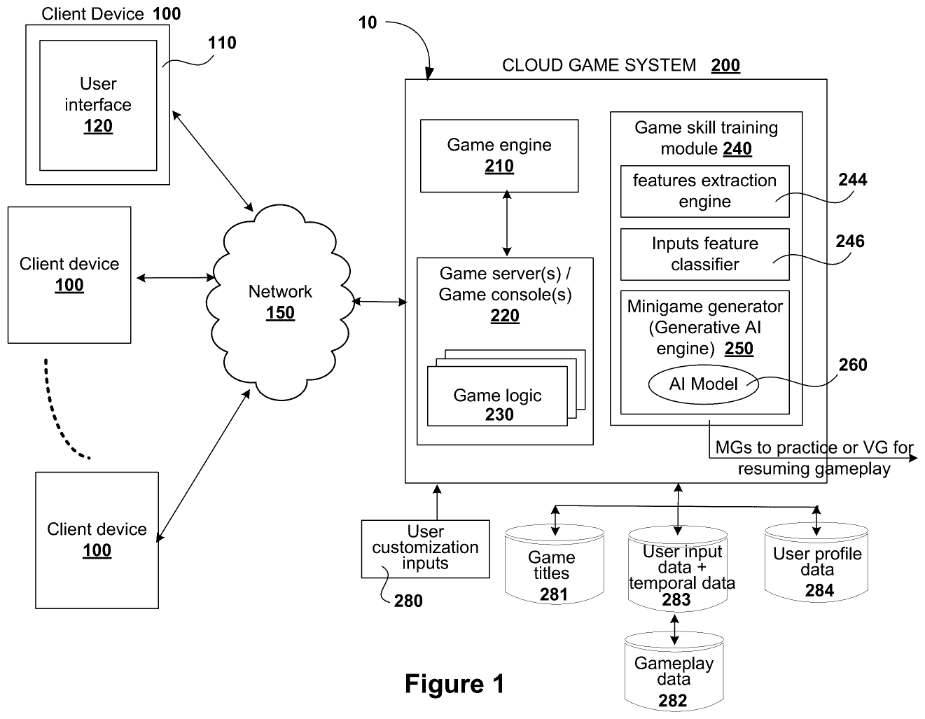

FIG. 1 represents a simplified block diagram of a system 10 having a game skill training module 240, which engages artificial intelligence (AI developed using machine learning algorithm) to analyze inputs provided by the user during one or more prior gameplay sessions of a video game and use the results of the analysis to generate minigames for the user to practice, before resuming or attempting gameplay of the video game. The system 10 is shown as a network enabled video gaming system that allows gameplay and spectating of gameplay of a plurality of video games, over a network 150, by users associated with one or more client devices 100. The video games can be single-player video games or multi-player video games. Users of the client devices 100 access the cloud game system 200 to select a video game for game play. In some implementations, the video game can be executed on one or more game servers (or game consoles) 220 of the cloud game system 200, wherein the game servers are located remotely from the client devices 100 of users and accessed via the network 150. A user interface 120 rendered on a display screen 110 associated with each client device 100 allows the user to access the cloud game system 200 and select the video game. The video game selected by each user can be a single-player game or a multi-player game. User selection of a video game is communicated to the cloud game system 200 via the network 150, where a game titles datastore 281 is used to verify the user request prior to providing access to the video game for gameplay. The game titles datastore 281 may be queried to obtain the game identifier of the video game selected by the user so that appropriate game logic 230 can be instantiated at the one or more game servers 220 within the cloud game system 200. The cloud game system 200 includes a plurality of game servers and/or game consoles 220 that are either co-located or remotely located and are configured to execute one or more instances of game logic 230 of one or more video games. A game engine 210 is used to provide the necessary processing resources (i.e., reusable resources, such as physics engine, audio engine, etc.,) for executing different aspects of the one or more video games and the game logic 230 provides the necessary logic for gameplay of the video game instantiated at the one or more game servers 220.

In some implementations, the client devices 100 can be thin clients and use resources of a server computing device (e.g., cloud game servers 220, remote servers, game consoles, etc.) for interpreting the user inputs provided at the client devices and for providing game related data for rendering at the respective client devices 100. In alternate implementations, the client devices 100 can be thick client devices with processor and memory, and resources that can be used to execute a portion of the video game locally. In these implementations, one or more servers (or server devices) 220 that are located remotely from the client devices 100 are configured to execute remaining portion of the video game. In yet other implementations, a single-player video game can be executed locally on the local client device 100 of a user and the gameplay of the user accessed over the network 150 of the system 10 by other users who wish to watch (i.e., spectate) the gameplay of the user.

In response to detecting selection of the video game by a user, the game skill training module 240 queries the gameplay datastore 282 to determine if the user had already played the selected video game during one or more prior gameplay sessions. The gameplay datastore 282 maintains historical gameplay data of each user's gameplay for each video game available at the cloud game system 200, wherein the gameplay data include game inputs provided by each user in each video game, game state data generated by applying the game inputs of each user, variations in the game state data as it relates to different users, in the case of multi-player video game (e.g., game data for each user, game content that correlates with each user's position in the video game, in the case of multi-player video game, etc.), etc. When the query returns some results (e.g., gameplay data), the results may be analyzed to determined when the user last played the video game. The gameplay data related to the user's prior gameplay are retrieved, parsed and inputs provided by the user for the video game are extracted and stored in user input datastore 283 and provided to the game skill training module 240 for processing. In addition to the user provided inputs, temporal data pertaining to the user's prior gameplay session are also extracted from the identified records of gameplay data and stored in the user input datastore 283 and provided to the game skill training module 240 for processing. The temporal data can be used to determine the amount of time that has elapsed between prior gameplay session and the current request for gameplay received from the user.

In some implementations, when the time elapsed between prior and current gameplay sessions exceeds a predefined period of time (e.g., 2 weeks, 1 month, 3 months, etc.), the game skill training module 240 may automatically provide a refresh option at the user interface to allow the user to refresh their memory of the input skills prior to attempting portions of the video game. In such implementations, it may have been determined from analysis of the user's inputs and the time elapsed that the user exhibited the required input skills during prior gameplay session. But due to their long absence from the video game, as determined by the amount of time that has elapsed from the user's prior gameplay and the current request for gameplay (i.e., time elapsed exceeding at least a predefined period of time), the game skill training module 240 may provide this refresh option so that the user can brush up on the input skills needed to play the video game. In some alternative implementations, it may be determined that the user has never played the video game before (i.e., determined from lack of gameplay data for the user for the video game returned for the query). In such implementations, the refresh option may be provided for practicing the input skills required for the video game. In yet other implementations, when it is determined that the user had played the video game and the time elapsed was less than the predefined period of time, it may be determined that the user had difficulty or could benefit from revisiting one or more portions of the video game. Based on such determination, the refresh option may be provided to allow the user to practice gameplay to build up their input skills required to successfully complete those portions prior to accessing the video game for gameplay.

When the user selects the refresh option, a minigame generator 250 identifies portions of the video game that provides the user with training to obtain the required input skills and generates a series of minigames for the user to practice their input skills. The portions of the video game to generate the series of minigames may be randomly selected by the game skill training module 240, when it is determined that the user is accessing the video game for gameplay for the first time or after an extended period of time. In the latter case, it might have been determined that the user had previously exhibited the input skills needed for the video game. In alternate implementations, the user may have played the video game and may have faced difficulty or may need additional training/practice in certain portions. In such implementations, the specific portions may be identified and minigames generated to cater to the user's specific needs. The game skill training module 240 engages a features extraction engine 244 to analyze the user inputs and to identify the various features of the inputs, an inputs feature classifier 246 to classify the input features, and a minigame generator 250 to use the classified features to generate and train an artificial intelligence (AI) model 260. The inputs used to generate the AI model 260 provide sufficient details to determine the input skills possessed by the user, input skills that the user could benefit by practicing, portions of the video game where the user was successful, portions of the video game the user had difficulty or would benefit by revisiting, etc. Outputs from the AI model 260 are used to identify the portions of the video game for generating the one or more minigames for those portions. The generated minigames are presented to the user for user selection and practice. The user's inputs for the minigames are monitored and, based on the observed input skills, either additional minigames may be generated and presented to the user to fine-tune the input skills gained by the user, or the user may be automatically transitioned to the video game to allow the user to play the video game. Equipped with the input skills gained from the practice, the user can play and successfully tackle/overcome the different challenges of the video game resulting in the user having a satisfactory gameplay experience.

In some cases, the user may provide inputs to the minigame generator 250 specifying the type of input skills that they would like to practice. These inputs are provided as user customization inputs 280. The minigame generator 250 can use the user customization inputs 280 to identify portions of the game that requires the input skills defined by the user customization inputs 280 and generate the minigames for the user to practice. Thus, the game skill training module 240 not only generates the minigames to train the user to master specific input skills that the system observes would help the user to navigate the video game but also allows the user to specify the input skills that they would like to acquire/master, leading to user providing inputs to customize the training to refresh the input skills of the user. By allowing user to personalize their training, the minigame generator provides the user with the flexibility of specifying the input skills that they would like to possess in addition to system identified input skills, thereby increasing the interest of the user in playing the video game.

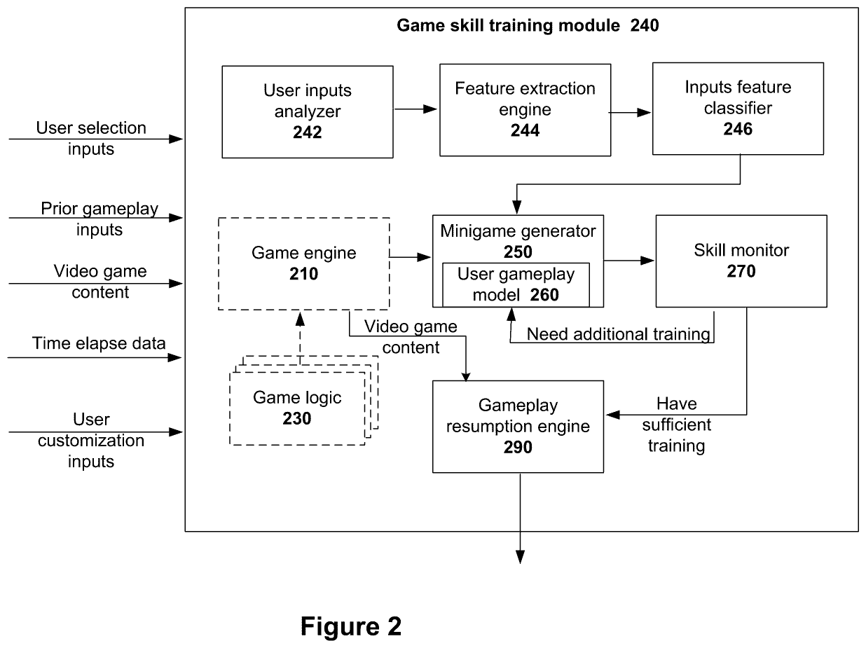

FIG. 2 illustrates the various sub-modules of the game skill training module 240 used in identifying portions of the video game for generating minigames to assist the user in gaining or refreshing necessary input skills for playing the video game, in one implementation. Some of the sub-modules within the game skill training module 240 include a user inputs analyzer 242, a feature extraction engine 244, inputs feature classifier 246, minigame generator 250, skill monitor 270 and a game resumption engine 290. The game skill training module 240 also communicates with game logic 230 either directly or via a game engine 210 to obtain the video game content of the video game for use in generating the minigames for different portions of the video game. Of course, the sub-modules listed above are provided as mere examples. Fewer or additional sub-modules may be provided for generating the minigames to assist the user to improve their input skills.

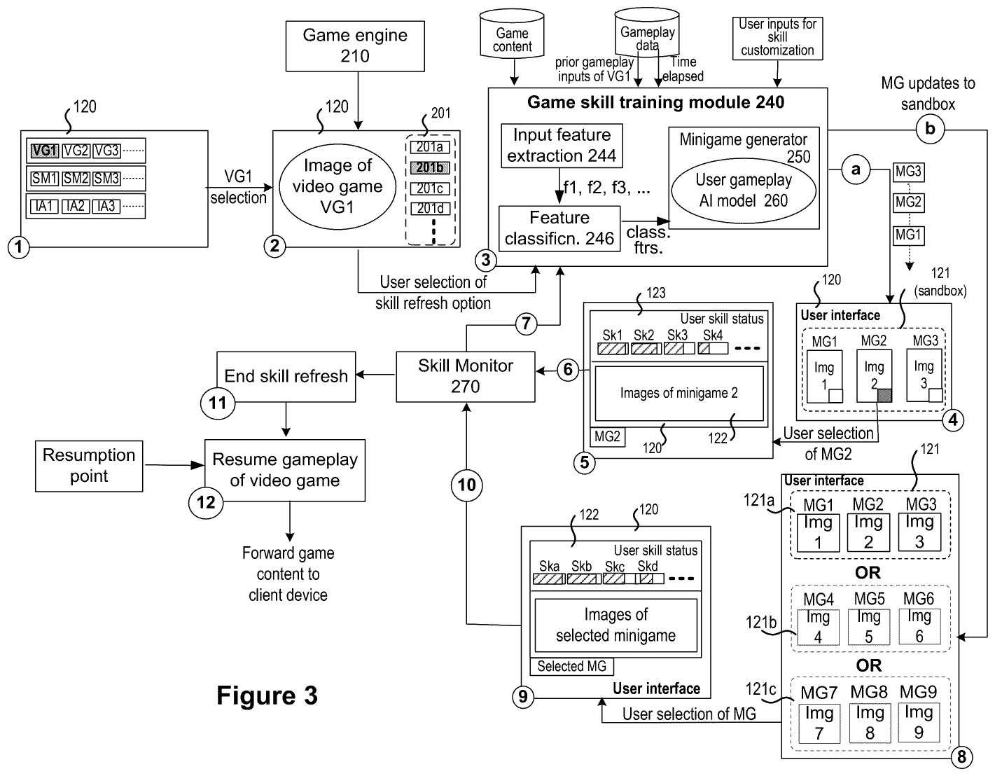

FIG. 3 illustrates the process flow for providing the user with the required assistance to gain or sharpen the input skills for playing the video game, in one implementation. It is to be noted that, in some implementations, the input skills required for a video game can change as the user progresses in the video game. For example, basic input skills may be required in the beginning of the video game and more advanced input skills required as the user progresses to higher levels. The minigame generator of the game skill training module 240 recognizes the varying input skills required at different levels/stages of the video game and proactively provides appropriate training assistance to the user as and when the game skill training module 240 recognizes the user struggling in different portions at different levels of the video game.

During gameplay of the video game, the game skill training module 240 monitors the inputs provided by the user and generates an AI model 260 to define outputs that can be used to identify portions of the video game for generating minigames. The generated minigames are presented to the user on a user interface for user selection and practice. The generated minigames are associated with corresponding executable code for the portion of the video game included within. The user can select any one or more of the minigames to practice their input skills. In some implementations, user selection of anyone of the minigames will result in the video game being paused for the user, executable code for the portion of the minigame selected by the user instantiated to allow the user to practice to gain the input skills, and the content for the portion presented to the user. The user can select more than one minigame to practice. User inputs in the minigames are monitored and when it is determined that the user has the necessary input skills to successfully attempt the more complex portions of the video game, the user, in some implementations, is automatically transitioned back to the video game allowing the user to continue the video game from where they left off when attempting the minigames. The user equipped with the enhanced input skills is able to progress in the complex portions of the video game. In alternate implementations, the user may be provided with additional minigames to further enhance their input skills prior to transitioning the user back to the video game.

As the user continues to play and progresses to higher levels in the video game, the game skill training module 240 dynamically updates the AI model 260 to refine the outputs. The game skill training module 240 can use the refined outputs from the updated AI model 260 to identify additional portions where the user may benefit from further practice and dynamically generate additional minigames for the additional portions so that the user can practice and gain the complex input skills to progress in the higher levels of the video game. In alternate implementations, the user may recognize the complex input skills required at the higher levels and may provide minigame-selection inputs for identifying portions of the video game and generating the additional minigames that can be used to practice the complex input skills. The process of updating the AI model based on the inputs of the user, the portions of the video game where the user can benefit from additional practice, and generating the additional minigames for those portions continue so long as the user is playing the video game or so long as the user expresses interest in receiving assistance.

The portions of the video game that are identified for inclusion in the minigames and additional minigames generated by the game skill training module 240 are for portions that the user has already played previously either in the prior or in the current gameplay session. The additional minigames generated for the user to practice are updated to the user interface 120 for user selection and practice. The minigames and the additional minigames may be generated in substantial real-time and are specific for the user and are based on the input skills exhibited by the user and/or the minigame attempted by the user. The user equipped with the enhanced input skills is able to progress in the complex portions of the video game, giving them a sense of achievement that they were able to overcome the challenges of the video game using the input skills they possess and not having to adjust any attributes of the video game, such as reducing the speed, adjusting complexity (e.g., easy level vs. medium level vs. hard level) of the video game, providing additional chances to achieve, etc. In various implementations, the minigames and the additional minigames are generated for the type of input skills that is to be exhibited by a game character representing the user within the video game, wherein the type of input skills are identified based on the characteristics of the game character. The input skills acquired by the user, the user's standing in the video game, the game character representing the user in the video game, etc., can be updated to the user profile of the user. The user profile of the user is updated to a user profile datastore 284, which can be queried as and when the user selects the video game for gameplay or when the user needs to be trained to improve their input skills.

Referring simultaneously to FIGS. 2 and 3, the process of providing minigames for the user to practice begins with user selection of a video game (e.g., VG1) for gameplay, as shown by the greyed out box in bubble 1 of FIG. 3. The video game VG1 may be selected from a user interface 120 rendered on a display screen 110 of a client device 100 of the user. The user interface can include a plurality of interactive applications, including video games (e.g., VG1, VG2, VG3, etc.), social media applications (e.g., SM1, SM2, SM3, etc.), other interactive applications (e.g., IA1, IA2, IA3, etc., such as email application, widgets, internet-based content applications (e.g., music, video, etc.,)), etc. Selection of the video game VG1 at the client device 100 is transmitted to the cloud game system 200, where the user providing the selection is verified and the request for gameplay of the video game is validated. Upon successful verification/validation, game titles datastore 281 (FIG. 1) is queried to retrieve the game logic 230 of the video game VG1 for execution using resources of the game engine 210, if the video game VG1 is not yet instantiated at the cloud game system 200. In response to the user selection of video game VG1, the cloud game system 200 returns an image of the video game VG1 along with a plurality of options (201) for rendering at the user interface 120 of the client device 100, as shown by bubble 2 (FIG. 3), in some implementations. The image of the video game VG1 and the plurality of options 201 are presented on the user interface 120 at the display screen 110 associated with the client device 100. Some of the options 201 that may be returned with the image of the selected video game VG1 may include game play option 201a, refresh game skills option 201b, social media interaction option 201c, gameplay chat option 201d, etc. (shown in bubble 2 of FIG. 3). Of course, the aforementioned options 201 are provided as a mere example and that some other or additional options may also be made available for user selection.

In some implementations, selection of the refresh game skills option 201b is done via explicit action by the user. In other implementations, the user selection of VG1 may result in the image of the selected video game VG1 along with automatic selection of the refresh game skills option 201b. The automatic selection may occur when it is determined that the user had not accessed the video game previously or had not accessed the video game for a substantial period of time (e.g., a day, a week, a month, a year, etc.) or may benefit from practicing some of the input skills, for example. User selection or automatic selection of refresh game skills option 201b (shown as the greyed-out box in bubble 2 of FIG. 3) is forwarded to the game skill training module 240 executing on a server of the cloud game system 200 (FIG. 1), as shown by bubble 3 in FIG. 3. The game skill training module 240, in response, queries the gameplay datastore 282 (FIG. 1) to retrieve gameplay data related to the prior gameplay of the video game VG1 by the user, where available. The gameplay data includes game inputs provided by the user, updates to game state resulting from applying the game inputs of the user, game content generated to represent the game state, etc. The gameplay data provides details of the game inputs, the portions of the video game where the game inputs were provided, key events occurring in those portions, game objects targeted by the game inputs, game objects affected by the game inputs, the user providing the game inputs, the game state of the video game resulting from applying the game inputs, time line of the gameplay, number of attempts by the user for completing the challenge presented in the portion that pertains to the key events, number of successful attempts, number of failed attempts, amount of time taken for each attempt, etc.

The gameplay data including the game inputs and the game-related data affected by the game inputs are extracted and provided as inputs to the user inputs analyzer 242 (FIG. 2). The user inputs analyzer 242 analyzes the inputs provided to identify the various features of the inputs provided by the user, including a type, sequence, speed, direction, the type of input device used for providing inputs, type of control buttons/controls provided, etc. The results of the analysis is provided to a feature extraction engine 244, which interprets and extracts the various features of the game inputs. In some implementations, the features are interpreted in accordance to a type of input device used and a hardware platform of the client device associated with the input device providing the game inputs. The features of the game inputs are classified using inputs feature classifier 246. The classification is done to identify the type of character representing the user in the video game providing the input, the skill level of the user, key event for which the game inputs are provided, portion and/or game level of the video game where the key event is occurring, the target of the game inputs, number of attempts registered for the key event, type and number of each type of attempts (e.g., successful attempts, failed attempts, incomplete attempts, etc.), game state resulting from the game inputs, etc.

The classified features are then used by a minigame generator 250 to build and train an artificial intelligence (AI) model 260 of user gameplay. The minigame generator 250 is a generative AI engine equipped with machine learning algorithm. The minigame generator 250 processes the classified features to determine data-driven outcomes and probabilistic outcomes related to the game inputs of the user, and use the inputs and resulting outcomes to generate and refine (i.e., train) the AI model 260. The AI model 260 is further refined/trained using the patterns and structures observed from the various inputs. Outputs from the AI model 260 are used to identify the input skills the user has acquired over time playing the video game, input skills that the user struggled during prior gameplay of the video game and can benefit by revisiting, specific location (i.e., portions) within the video game where the user struggled during prior gameplay, etc. The game skill training module uses the outputs of the AI model 260 to generate minigames for different portions of the video game that the user has played and that the game skill training module has identified as portions where the user has struggled or can benefit from further training. In some implementations, the game skill training module may recognize that the user has acquired the required input skills from prior gameplay session of the video game but may require a skill refresh due to the user's extended period away from the video game. In such implementations, the game skill training module 240 may randomly identify portions of the video game to generate the minigames. In some implementations, the AI model 260 may also be trained using inputs provided by other users. In such implementations, the outputs of the AI model 260 can be identified by matching the user profile of the user with the user profiles of other users. The user profiles may be used to match the user's skills with other users skills and the locations where the other users also struggled to progress or benefited from additional practice.

In some implementations, each minigame is generated by taking into consideration characteristics of a character used for representing the user in the video game. The characteristics of the character identify a type of input skills exhibited by the character in the gameplay, and each minigame is generated to improve the type of input skills exhibited by the character representing the user. For example, the character may be an expert marksman or may be a person exhibiting aggressive behavior or an offensive/defensive tactic during gameplay. As a result, the minigames generated for the character of the user takes into consideration the characteristics of the character and include portions of the video game for practicing the appropriate input skills that match the characters interactions so that the user is able to practice and improve the type of input skills that is appropriate for the character. As noted, in some implementations, the training option is provided to the user based on evaluation of the input skills acquired by the user during prior gameplay sessions.

A series of minigames, (e.g., MG1, MG2 and MG3 shown in FIG. 3) are generated for the portions of the video game that the game skill training module 240 has identified for the user to practice. In alternate implementations, the game skill training module 240 can identify random portions of the video game to generate minigames for the user. The randomly identified portions may be to allow the user to refresh their “muscle” memory (i.e., input skills) and can be identified upon detecting that the user had previously exhibited the necessary input skills but may need to refresh their memory after a long absence from the video game. Each minigame that is generated requires a distinct set of input skills for the challenges associated with the key event included therein. The generated minigames (MG1, MG2, MG3) are forwarded to the client device of the user, as illustrated by bubble ‘a’ in FIG. 3. The minigames are presented at the user interface 120 of the client device with representative figures, as shown by bubble 4 in FIG. 3. In some implementations, the representative figure of each minigame may be related to a key event that is contained in the portion of the video game included in the minigame. In some implementations, the minigames are provided in a sandbox 121 (i.e., sandbox environment) in the form of thumbnails. Each thumbnail includes is distinct key event that requires a distinct set of input skills and is presented with an image representation of the key event included within. When more than one key event is included in the thumbnail, the key event that is more prominent is identified, and the image representation of the prominent key event is used when presenting the thumbnail. The sandbox 121, in some implementations, provides the user with an open arena for practicing the gameplay skills by allowing the user to select the minigames in a non-linear manner (i.e., does not have to follow any particular sequence when selecting the minigames). For instance, in the above example of the series of minigames MG1, MG2, MG3 provided, the user can select any one of the thumbnails associated with the minigames (MG1, MG2, MG3) for practicing their input skills and once they acquired the input skills required for achieving the challenges contained within, they can select any other minigame. Thus, for example, the user can select MG2 to practice and once they acquire the skill set required to achieve/overcome MG2 challenges, the user can select MG1 followed by MG3. The thumbnails representing the minigames include storylines corresponding to the different portions of the video game that are non-linear (i.e., independent, meaning storyline included in a successive thumbnail is not dependent on a storyline of a previous thumbnail). In some implementations, although the user is allowed to select the minigames in the sandbox 121 in a non-linear manner, the input skills acquired by playing the minigames are building the input skills of the user in a linear manner.

In the example illustrated in FIG. 3, it is shown that the user has selected minigame MG2 for practicing their input skills, as shown by the greyed-out selection box related to minigame MG2 in bubble 4. In response to the user selection of minigame MG2, the executable code of the portion of the video game associated with minigame MG2 is instantiated and the game content is presented at the user interface 120 for the user's gameplay, as shown by bubble 5 of FIG. 3. As noted, each minigame requires a distinct set of inputs to accomplish the challenges associated with one or more key events included within. As the user plays the minigame MG2, the user's gameplay is monitored, each input skill (e.g., speed, sequence, number, etc.) identified, and the status of each input skill for the user is determined by evaluating the user's inputs. As the user practices their inputs, the input skills of the user can improve. In some implementation, as the user provides their inputs, the status of each input skill exhibited by the user is presented in a visual manner during gameplay of the minigame to show the user how they are progressing with respect to the input skills required to accomplish the key event(s) included in the selected minigame. In some implementations, the input skills required for the minigame MG2 and the status of each input skill acquired by the user may be presented in a boxplot format in a portion (e.g., top portion 123) of the user interface 120, as illustrated in bubble 5 of FIG. 3, with each box representing a distinct input skill required for achieving the challenges included in the selected minigame MG2. In alternate implementations, the input skills may be presented as a line graph or a bar graph or in any other format that is easy to represent and decipherable by the user.

The inputs provided by the user during a current gameplay of the minigame MG2 are evaluated by a skill monitor 270, as represented by bubble 6 in FIG. 3, to determine the progress made by the user in the minigame MG2 and the input skills acquired by the user from the gameplay of the minigame MG2. The inputs provided by the user during the current gameplay of the minigame MG2 are updated to the AI model 260 so that the current input skills of the user can be determined. The AI model 260 updated with the results of the evaluation from the skill monitor are used by the game skill training module 240, to update the user interface 120 of the client device 100 of the user.

Once the user has mastered the challenges included in minigame MG2, the user may be presented with the option of trying the other minigames (e.g., MG1 and MG3) that was originally presented with minigame MG2. Accordingly, the user interface 120 is updated to include the first set of minigames MG1, MG2 and MG3, as shown in sandbox 121a in FIG. 3. Alternately, it may be determined that the user struggled with the challenges in minigame MG2 and would benefit with continued assistance from the game skill training module 240. Such determination may be made based on the amount of progress made by the user in the minigame MG2. In such cases, the game skill training module 240 identifies other portions of the video game that may require certain ones of the input skills that are less complex than the input skills required for achieving the challenges of minigame MG2. The game skill training module 240 uses the other portions of the video game to generate one or a series of additional minigames (e.g., MG4, MG5, MG6) for the user to practice and master. The additional minigames MG4, MG5 and MG6 are updated to sandbox 121b at the user interface 120 for user selection, as shown in FIG. 3. The presentation of the additional minigames in sandbox 121b allow the user to select any of the additional minigames MG4, MG5 or MG6 in a non-linear manner and practice the input skills contained within. Once the user masters the less complex input skills provided in minigames MG4, MG5 and/or MG6, the user may be presented with the minigames MG1, MG2 and MG3 in sandbox 121 to enable the user to build up on their input skills.

In yet another implementation, it may be determined that the user acquired the input skills for achieving the challenges in minigame MG2 and any other minigames (MG1 or MG3) that the user attempted from sandbox 121. The game skill training module 240 recognizes the user's acquisition of the input skills from the minigames presented in sandbox 121 and, in response, may present additional minigames of increased complexity for the user to practice to further improve their input skills. In some implementations, the complexity of the additional minigames may be defined based on the case with which the user mastered the distinct input skills of the minigame selected by the user for gameplay during a current gameplay session. Alternately, once the user has acquired the inputs skills from the minigames presented in sandbox 121, the user may want to challenge themselves and try to achieve additional input skills that they can use during gameplay of the video game. In such implementations, the user themselves may provide inputs to customize the minigames generated by the game skill training module 240. The user customization inputs (also referred to as “minigame-selection inputs” as the customization inputs are used to select the portions and generate the minigames of increased complexity) may be used by the game skill training module 240 to identify portions of the video game that requires the input skills of greater complexity specified by the user than what was required for the minigames MG1, MG2 and MG3 presented in sandbox 121. The identified portions are used to generate the minigames MG7, MG8 and MG9 and update the user interface 120 representing sandbox 121c, as shown in FIG. 3. User gameplay of anyone of the minigames MG7, MG8 and MG9 are tracked and the input skills of the user are updated based on the progress made in the respective minigames attempted by the user.

Thus, the user inputs in the different minigames presented in the user interface 120 are tracked and the user interface 120 updated with additional minigames, if the game skill training module 240 or the user determine that the user needs additional training prior to playing the video game. User selection of any one of the minigames from sandbox 121a or 121b or 121c are used to instantiate the relevant portion of the video game by executing a corresponding executable code for the relevant portion of the video game and the inputs provided by the user are monitored during game play of the selected minigame, as illustrated in bubble ‘9’ in FIG. 3. The game inputs provided by the user are monitored by the skill monitor 270, as shown in bubble ‘10’ in FIG. 3. In some implementations, the gameplay of the selected minigame is monitored and real-time feedback provided to the user. The real-time feedback, based on user's performance in the attempted minigame, can provide constructive suggestions and tips to the user. The real-time feedback, in some implementations, can be any one of a textual suggestion, a verbal suggestion, visual input tips or haptic input tips or audio input tips using user interface elements, timing indicators, and/or screen prompts.

In some implementations, the portions of the video game included in the minigames correspond to storylines of the video game that are non-linear. In some implementations, each minigame can include a tutorial option. The user can attempt the minigame provided at the user interface and when the user experiences difficulty in completing the challenges included in the minigame can select the tutorial option. In some implementations, the tutorial option, when activated, provides guidance to the user for providing game inputs required for progressing in the portion of the video game included in the selected minigame. The tutorial option can be provided in the form of a textual or a visual or a video or an audio or a haptic guidance. It should be noted that each minigame is generated to include portion of the video game that the user has already attempted either in the prior gameplay session or the current gameplay session. Thus, in order to avoid spoiler alerts, the minigames are generated to include guardrails that prevent the user from getting exposed to other portions of the video game that the user has not yet attempted. The minigame generator uses a resumption point (i.e., a point in the video game where the user left off) as the outer limit of the video game that can be exposed to the user and each minigame is generated to include portion of the video game that is within the outer limit of the video game defined by the resumption point.

The skill monitor 270 evaluates the inputs to determine the game skills acquired by the user during current gameplay of any one or all of the minigames presented to the user at the user interface 120. When the skill monitor 270 determines that the user has not acquired sufficient input skills, the skill monitor 270 signals to the game skill training module 240 to provide additional minigames for the user to practice and the evaluation of the game inputs to determine the progress made in the additional minigames continues till the game skill training module determines that the user has acquired the input skills or the user feels comfortable to resume gameplay of the video game. When the skill monitor 270 determines or the user decides that the user has acquired sufficient input skills, the skill monitor 270 sends a signal to the game resumption engine 290 (in FIG. 2) to end the skill refresh process, as illustrated by bubble ‘11’ in FIG. 3. The user may decide that they have sufficient input skills to use during gameplay of the video game, and may select an “End Skill Refresh” option (not shown) or resumption option (not shown) provided at the user interface to resume gameplay of the video game, in one implementation. In some implementations, during evaluation, the skill monitor 270 may detect that the user has acquired sufficient amount of distinct set of input skills (i.e., at least a predefined amount of the distinct set of input skills) included in the one or more minigames attempted by the user and automatically provide the end skill refresh option or the resumption to end skill refresh and resume gameplay of the video game. The resumption option for resuming gameplay of the video game can identify the beginning or a point where the user left off in the prior gameplay session or a point within the video game where the user would like to resume gameplay.

Responsive to the signal generated by the skill monitor 270, the game resumption engine 290 concludes the skill refresh process, queries the gameplay datastore 282 to identify a resumption point from prior gameplay session for resuming the gameplay of the video game for the user, and automatically restarts the video game from the resumption point. In some implementations, the resumption point is defined as the point where the user ended (i.e., stopped or paused) their gameplay during prior gameplay session. In some implementations, the resumption point identified from prior gameplay session maybe further refined using inputs from the user. In alternate implementations, the resumption point may be a user-defined point within the video game. In yet other implementations, the resumption point may be identified to be the beginning of the video game. The game resumption engine 290 then automatically restarts (i.e., resumes) the gameplay of the video game from the resumption point defined for or by the user, as illustrated by bubble ‘12’ in FIG. 3. The user equipped with the game skills acquired from practice of the minigames is able to successfully attempt and complete the challenges present in the video game. The game content representing the game state of the video game is presented at the client device of the user to allow the user to interact.

If, at any time, the user finds it difficult to complete the challenges in any portion of the video game, the user can select the skill refresh option or the system can recognize the user's difficulty and provide the skill refresh option. In response, the game skill training module 240 will pause the gameplay, generate the appropriate minigames, and allow the user to practice the input skills. The training or practice provided to the user via minigames by the game skill training module 240 allows the user to gain the input skills as and when needed and such training is done without affecting the gameplay of the video game.

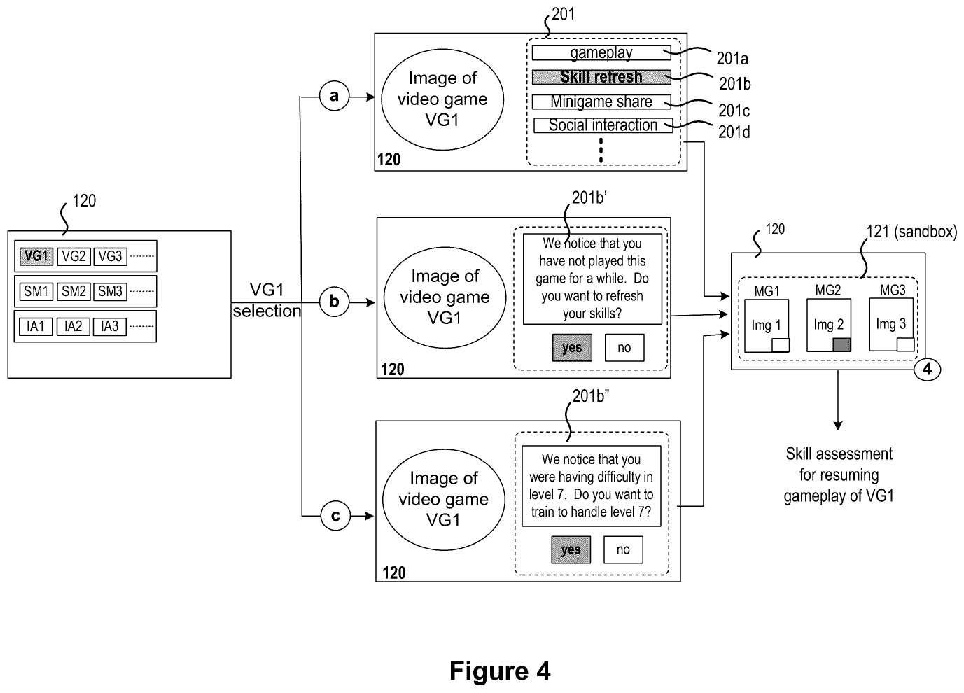

FIG. 4 illustrates different examples of skill refresh option provided to the user in a user interface, in some implementations. As noted previously, when the user selects the video game (e.g., VG1), an image representation of the video game VG1 along with different selection options 201 available to the user are presented in a user interface 120 rendered at a display screen 110 of the associated client device 100 of the user. In one implementation, the skill refresh option (i.e., training option) 201b can be one of many options (201a, 201b, 201c, 201d, etc.) provided as selection options 201, as shown by bubble ‘a’. In alternate implementation, the skill refresh option (201b′) may be provided in the form of a text box that includes a message informing the user about the amount of time that has elapsed since the user last interacted with the video game with “Yes” and “No” options to select or not select the skill refresh option, as shown by bubble ‘b’. In yet another alternate implementation, a pop-up text window may be provided identifying a specific location within the video game where the user was shown to be struggling with “Yes” and “No” options to select or not select the skill refresh option, as shown by bubble ‘c’. Irrespective of the way the skill refresh option is presented, the user is provided with the ability to refresh or improve their input skills so that the user can enjoy the full version of the video game instead of a scaled-down version, enabling the user to have a satisfactory gameplay experience. The skill refresh option allows the user to improve their input skills without leaving the video game and without adjusting (i.e., scaling down the video game attributes.

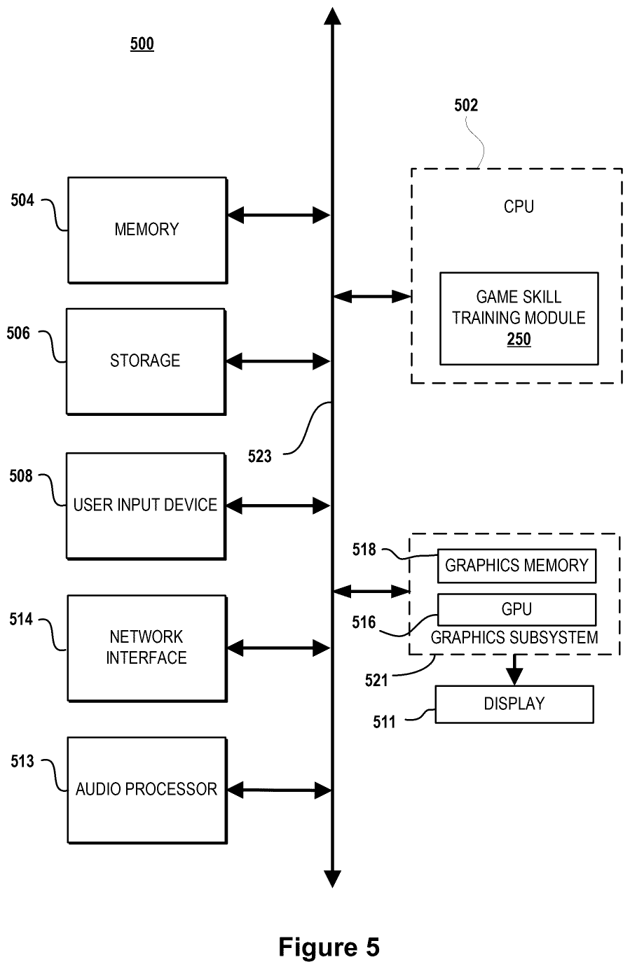

FIG. 5 illustrates components of an example device 500 (e.g., server device 220 of FIG. 1) that can be used to perform aspects of the various embodiments of the present disclosure. This block diagram illustrates a device 500 that can incorporate or can be a personal computer, video game console, personal digital assistant, a server or other digital device, suitable for practicing an embodiment of the disclosure. Device 500 includes a central processing unit (CPU) 502 for running software applications and optionally an operating system. CPU 502 may be comprised of one or more homogeneous or heterogeneous processing cores. For example, CPU 502 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 500 may be a localized to a player playing a game segment (e.g., game console), or remote from the player (e.g., back-end server processor), or one of many servers using virtualization in a game cloud system for remote streaming of gameplay to clients.

Memory 504 stores applications and data for use by the CPU 502. Storage 506 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 508 communicate user inputs from one or more users to device 500, examples of which may include keyboards, mice, joysticks, touch pads, touch screens, still or video recorders/cameras, tracking devices for recognizing gestures, and/or microphones. Network interface 514 allows device 500 to communicate with other computer systems via an electronic communications network, and may include wired or wireless communication over local area networks and wide area networks such as the internet. An audio processor 513 is adapted to generate analog or digital audio output from instructions and/or data provided by the CPU 502, memory 504, and/or storage 506. The components of device 500, including CPU 502, memory 504, (data) storage 506, user input devices 508, network interface 514, and audio processor 513 are connected via one or more data buses 523.

A graphics subsystem 521 is further connected with data bus 523 and the components of the device 500. The graphics subsystem 521 includes a graphics processing unit (GPU) 516 and graphics memory 518. Graphics memory 518 includes a display memory (e.g., a frame buffer) used for storing pixel data for each pixel of an output image. Graphics memory 518 can be integrated in the same device as GPU 516, connected as a separate device with GPU 516, and/or implemented within memory 504. Pixel data can be provided to graphics memory 518 directly from the CPU 502. Alternatively, CPU 502 provides the GPU 516 with data and/or instructions defining the desired output images, from which the GPU 516 generates the pixel data of one or more output images. The data and/or instructions defining the desired output images can be stored in memory 504 and/or graphics memory 518. In an embodiment, the GPU 516 includes 3D rendering capabilities for generating pixel data for output images from instructions and data defining the geometry, lighting, shading, texturing, motion, and/or camera parameters for a scene. The GPU 516 can further include one or more programmable execution units capable of executing shader programs.

The graphics subsystem 521 periodically outputs pixel data for an image from graphics memory 518 to be displayed on display device 511. Display device 511 can be any device capable of displaying visual information in response to a signal from the device 500, including CRT, LCD, plasma, and OLED displays. Device 500 can provide the display device 511 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with clastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method, comprising:
detecting selection of a training option from a user interface rendered on a client device for a video game selected by a user for gameplay, the training option allowing the user to improve on input skills for use during the gameplay of the video game;
forwarding a plurality of minigames for rendering on the user interface, in response to the selection of the training option by the user, the plurality of minigames for improving the input skills of the user are identified based on analysis of game inputs collected from one or more prior gameplay sessions of the user, each minigame of the plurality of minigames includes a portion of the video game that requires a distinct set of input skills to progress in said portion of the video game;
detecting selection of a minigame from the plurality of minigames presented at the user interface, the selection of the minigame by the user causing instantiation of an executable code for the portion of the video game to allow the user to practice the distinct set of input skills for the portion;
monitoring the input skills exhibited by the user during gameplay of the minigame selected by the user to identify an amount of progress made by the user in said portion of the video game; and
providing updates to the user interface, based on the input skills exhibited by the user during gameplay of the minigame selected by the user, the updates used to allow the user to improve the input skills and use the improved input skills for gameplay of the video game,
wherein operations of the method are performed by a game skill training module executing on a server computing device communicatively coupled to the client device.

2. The method of claim 1, wherein providing updates to the user interface includes providing an option for resuming the gameplay of the video game, the option provided upon detecting the user has acquired at least a predefined amount of the distinct set of input skills included in the minigame selected by the user.

3. The method of claim 2, wherein the option for resuming the gameplay includes a first option to begin the gameplay of the video game from a beginning, and a second option to resume the gameplay from a resumption point, wherein the resumption point is defined by the user or is determined from the one or more prior gameplay sessions of the user for the video game, and
wherein the resumption point is identified to be a point where the user stopped the gameplay or where the user had difficulty in progressing in the video game.

4. The method of claim 1, wherein providing updates to the user interface further including, tracking the progress of the user during the gameplay of the portion of the video game included in the minigame selected for practicing, the tracking performed by analyzing inputs provided by the user during current gameplay of the minigame, the analyzing of inputs used to determine a level of difficulty experienced by the user in successfully completing the minigame during the current gameplay; and
dynamically identifying and forwarding additional minigames as updates to the user interface, the additional minigames identified to adapt to the level of difficulty experience by the user, the additional minigames are specific to the user and the minigame selected for practicing by the user.

5. The method of claim 4, wherein each of the additional minigames is identified automatically by the game skill training module or is identified based on minigame-selection inputs provided by the user, and
wherein the minigame-selection inputs define complexity of skills desired by the user for practicing, and the game skill training module identifies said each of the additional minigames based on said minigame-selection inputs of the user.

6. The method of claim 4, wherein each of the additional minigames is generated and presented on the user interface for user selection in substantial real-time, based on progress made in the minigame selected by the user for practicing.

7. The method of claim 4, wherein each of the additional minigames for updating the user interface is identified to include a select portion of the video game that requires certain ones of basic input skills required to successfully attempt the distinct set of input skills of the minigame selected for practicing by the user, said each of the additional minigames for acquiring said certain ones of the basic input skills identified based on the level of difficulty experienced by the user during current gameplay of the minigame selected by the user.

8. The method of claim 4, wherein each of the additional minigames for updating the user interface is identified to include a select portion of the video game that requires certain ones of advanced input skills the user desires to acquire for progressing in the video game, said each of the additional minigames for acquiring said certain ones of the advanced input skills identified based on the input skills exhibited by the user during current gameplay of the minigame selected by the user.

9. The method of claim 1, wherein the plurality of minigames is presented as thumbnails in a sandbox for selection by the user, the sandbox allowing a non-linear selection of any one of the thumbnails for accessing and practicing a corresponding portion of the video game included therein,
wherein selection of any one of said thumbnail by the user used to build the input skills of the user necessary for progressing in the video game in a linear manner, and
wherein the portion of the video game included in corresponding minigame associated with each thumbnail includes a key event of the video game.

10. The method of claim 1, wherein the monitoring of the input skills further includes providing real-time feedback to the user during current gameplay of the minigame selected by the user for practicing, the real-time feedback provided as any one of a textual suggestion, a verbal suggestion, visual input tips or haptic input tips or audio input tips using user interface elements, timing indicators, and screen prompts, and
wherein the portion of the video game included in each of the plurality of minigames presented in the user interface corresponds to a storyline of the video game that is non-linear.

11. The method of claim 1, wherein each minigame of the plurality of minigames includes a tutorial option, which when activated by a selection option provided on the user interface, provides guidance to the user for providing game inputs required for progressing in the portion of the video game included in said each minigame, the tutorial option provided in a textual or a visual or an audio or a haptic guidance format.

12. The method of claim 1, wherein each minigame of the plurality of minigames is generated to include guardrails for the portion of the video game, the guardrails identified to prevent exposing the user to other portions of the video game that are beyond a resumption point, wherein the resumption point is a point in the video game where the user has paused their gameplay.

13. The method of claim 1, wherein the portion of the video game included in each minigame of the plurality of minigames is identified as the portion that the user previously attempted during prior gameplay session.

14. The method of claim 1, wherein the monitoring of the progress in the minigame further includes presenting a visual representation of the progress made by the user on the user interface during the gameplay of said minigame in a current gameplay session.

15. The method of claim 1, wherein each minigame of the plurality of minigames is generated by taking into consideration characteristics of a character used for representing the user in the video game, the characteristics identifying a type of input skills exhibited by the character in the gameplay of the video game during the prior gameplay sessions, and said each minigame is generated to improve the type of input skills exhibited by the character representing the user.

16. The method of claim 1, wherein the training option is provided to the user based on evaluation of the input skills retrieved from the prior gameplay sessions of the user and one or more of other users who have played the video game.

17. The method of claim 1, wherein the plurality of minigames is identified and presented by a machine learning algorithm, the machine learning algorithm building and training an artificial intelligence (AI) model using the inputs skills of the user identified and extracted from one or more of the prior gameplay sessions and game state of the video game.

18. The method of claim 1, wherein the plurality of minigames is presented as thumbnails, wherein each thumbnail includes a distinct key event that can be achieved with the input skills required by the user to progress in the video game, each of the thumbnails is presented to include an image representation of the distinct key event associated with said each thumbnail.

19. A method, comprising:
detecting selection of a video game for gameplay from a user;
determining an amount of time that has elapsed since the user previously selected the video game for the gameplay;
when the amount of time elapsed exceeds a predefined period of time, presenting a training option on a user interface for user selection to enable the user to refresh their input skills for use in the gameplay of the video game;
responsive to the user selection of the training option, presenting a plurality of minigames on the user interface, each minigame of the plurality of minigames including a portion of the video game that requires a distinct set of input skills and is identified to enable the user to improve the input skills for progressing in the video game;
detecting selection of a minigame from the plurality of minigames presented at the user interface, the selection of the minigame by the user for current gameplay causing instantiation of an executable code for the portion of the video game to allow the user to practice the distinct set of input skills for the portion;
monitoring the input skills exhibited by the user during the current gameplay of the minigame selected for gameplay to identify an amount of progress made by the user in said portion of the video game; and
updating the user interface, based on the input skills exhibited by the user.

20. The method of claim 19, wherein presenting the plurality of minigames further includes,
evaluating input skills exhibited by the user during a prior gameplay session, to identify skill sets required by the user to progress in the video game; and
identifying the plurality of minigames for presenting to the user, wherein each minigame of the plurality of minigames is identified to include the portion of the video game that requires at least a portion of the skill sets required by the user to progress in the video game.

21. The method of claim 19, wherein the predefined period of time defined for determining the amount of time elapsed between a prior gameplay session and a current gameplay session of the video game and for providing the training option is specific to the user and is defined based on the input skills exhibited by the user during the prior gameplay session of the video game.
